(19) United States
(12) Patent Application Publication
(10) Pub. No.: US 2012/0314616 A1
(43) Pub. Date: Dec. 13, 2012

(54) METHOD AND APPARATUS PERTAINING TO DATA-SESSION PEAK-THROUGHPUT MEASUREMENTS

(76) Inventors: Tengywe Eric Hong, Naperville, IL (US); Jagadeesh Dantuluri, Aurora, IL (US); Vishal Sharma, Aurora, IL (US)

(21) Appl. No.: 13/514,503

(22) PCT Filed: Dec. 9, 2010
(86) PCT No.: PCT/US10/59708

§ 371 Date: Aug. 24, 2012

Related U.S. Application Data
(60) Provisional application No. 61/267,949, filed on Dec. 9, 2009.

(51) Int. Cl. H04W 24/00

(52) U.S. Cl. 370/253

(57) ABSTRACT

A network monitoring device performs peak-throughput measurements for each of a plurality of data sessions in a network to provide corresponding peak-throughput values. The network monitoring device then filters the peak-throughput values to remove peak-throughput values that correspond to data sessions that fail to at least meet a relevant standard to provide filtered peak-throughput values. By one approach, these peak-throughput measurements can comprise a plurality of relatively short-duration peak-throughput measurements. The aforementioned relevant standard can vary with the needs and/or opportunities as tend to characterize a given application setting. By one approach these teachings will further comprise filtering the peak-throughput values to remove peak-throughput values that correspond to portions of data sessions where data-throughput speeds are intentionally low for reasons other than throughput-limit conditions. By one approach, these teachings will further comprise using the filtered peak-throughput values to aggregate statistics regarding peak-throughput performance for the network.

### RELATED APPLICATION(S)

This application claims the benefit of U.S. Provisional application No. 61/267,949, filed Dec. 9, 2009, which is incorporated by reference in its entirety herein.

### TECHNICAL FIELD

This invention relates generally to the measurement of peak-throughput data transmission rates.

### BACKGROUND

Communications networks of various kinds are known in the art. This includes networks that bear end-user data transmissions via one or more streams of data packets. Increasingly, many such data-bearing networks are mobile networks (in that the end-user platform is mobile and may move from place to place even while transmitting or receiving). Modem cellular telephony networks are one salient example in this regard.

Managing a network (including but not limited to mobile networks) comprises a challenging task. At the very least the manager wishes to be apprised of system failures (where, for example, a service-delivery component fails). Beyond this, the responsible manager also wishes to understand where a given network may be underperforming or overperforming and under what circumstances. Various known metrics are sometimes relied upon to help in developing such an understanding.

As one example in these regards, it is known to monitor peak user data throughput rates. Unfortunately, while sometimes helpful to some extent, existing peak user data throughput monitoring practices leave much to be desired. Some existing practices, for example, may provide a false view of a typical user's actual experience and certainly may fail to provide an accurate view of a specific user's actual experiences (especially over any extended period of time).

### BRIEF DESCRIPTION OF THE DRAWINGS

The above needs are at least partially met through provision of the method and apparatus pertaining to data-session peak-throughput measurements described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention;

FIG. 6 comprises a flow diagram as configured in accordance with various embodiments of the invention; and

FIG. 7 comprises a flow diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a network monitoring device performs peak-throughput measurements for each of a plurality of data sessions in a network to provide corresponding peak-throughput values. The network monitoring device then filters the peak-throughput values to remove peak-throughput values that correspond to data sessions that fail to at least meet a relevant standard to provide filtered peak-throughput values.

By one approach, these peak-throughput measurements can comprise a plurality of relatively short-duration peak-throughput measurements. The duration might be, for example, about one second. Sub-second durations may also serve in these regards if desired.

The aforementioned relevant standard can vary with the needs and/or opportunities as tend to characterize a given application setting. As one illustrative example, this standard can comprise a requirement that the data session pertain to transporting at least a minimum predetermined quantity of data. So configured, this process can effectively ignore low-data-volume sessions where higher data throughput rates are neither ordinarily expected nor necessary.

By one approach these teachings can further comprise filtering the peak-throughput values to remove peak-throughput values that correspond to portions of data sessions where data-throughput speeds are intentionally low for reasons other than throughput-limited conditions. As one illustrative example in these regards, this can comprise only passing packets for portions of a data session that pertain to allowed higher data-throughput rates. So configured, this process can effectively ignore portions of a data session where data-throughput rates are limited for protocol reasons and not for reasons pertaining to application-setting variables and circumstances.

By one approach, if desired, these teachings will further comprise using the filtered peak-throughput values to aggregate statistics regarding peak-throughput performance for the network. This can comprise, for example, aggregating the statistics on an individual network service-delivery component basis. This can also comprise, in lieu of the foregoing or in combination therewith, aggregating the statistics on a user-by-user basis.

The availability of such information, and the statistical aggregation of such information in any of a variety of ways, greatly facilitates the opportunity to provide a reliable and detailed view of peak-throughput rates for a given data network. It will be appreciated that these teachings are useful with mobile networks as well as non-mobile networks.

This information can be provided on a real-time basis if desired, and can certainly be aggregated over time to provide short-term and long-term views as well. By one approach these teachings can be leveraged to provide, for example, information regarding the peak-throughput experiences of a given end user for each of their sessions over the course, say, of a month. By another approach these teachings can be leveraged to provide information that can help to identify failing and/or under-resourced service-delivery components that comprise a part of the network. When employing these teachings to assess the performance of a given service delivery component, for example, the statistically significant volume of packet traffic associated with such a component may permit useful views to be developed over relatively short periods of time (such as a few hours or a single day).

These teachings are readily implemented via a minimal number of monitoring platforms if desired. This can comprise, for example, installing the aforementioned network monitoring device to have access to the packet stream(s) for the network at a data-aggregation point.

In any event, these teachings are readily implemented in economical ways and can provide unprecedented levels of information regarding the user experience and or the performance of individual service-delivery components.

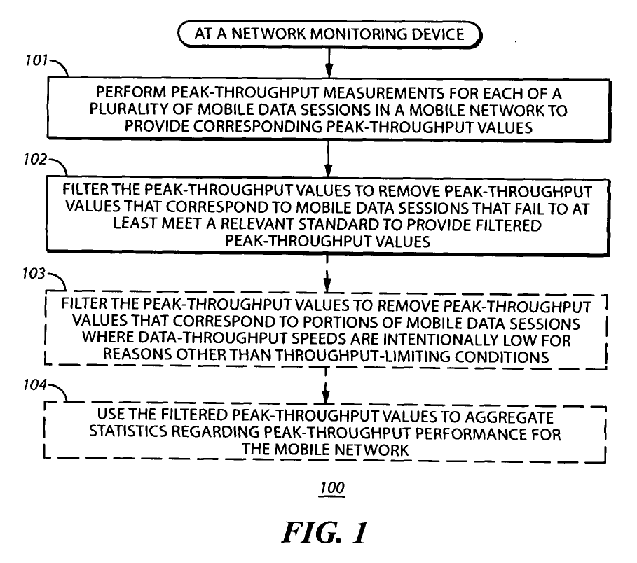

These and other benefits may become clearer upon making a thorough review and study of the following detailed description. Referring now to the drawings, and in particular to FIG. 1, an illustrative process 100 that is compatible with many of these teachings will now be presented. For the sake of illustration this description presumes that a network monitoring device carries out this process 100. Further explanation in those regards is provided further herein. Also, for the sake of example and without intending any limitations in these regards, the following description will presume that the network comprises a mobile network.

At step 101 this process 100 performs peak-throughput measurements for each of a plurality of mobile data sessions in a mobile network to provide corresponding peak-throughput values. Generally speaking, a peak-throughput measurement metricizes a highest rate of data throughput experienced for a given mobile data session during some sampling period. By one approach this can comprise the actual value of the data throughput rate. By another approach, if desired, this can comprise a quantized value where specific data-throughput rates are correlated to specified ranges. As a trivial example in these regards, the actual observed data-throughput rates could be categorized as being one of “low,” “nominal,” and “high.”

The specific ranges of time over which a relative peak-throughput measurement is taken can of course vary with the application setting. By one approach such a measurement could be taken over a relatively long period of time, such as every minute. Generally speaking, for many application settings it may be useful to utilize a considerably smaller duration of time. This might comprise, for example, selecting a peak-throughput value for each one second of time. As another example, this step could comprise performing a plurality of sub-second peak-throughput measurements. Using this approach, for example, a peak-throughput measurement could be taken for each 0.5 seconds, for each 0.25 seconds, or for some other sub-second duration of time of interest.

In many cases, this step 101 can comprise monitoring one or more packet streams in the aforementioned mobile data network. Using this approach a plurality of mobile data sessions that all utilize the monitored packet stream(s) can all be simultaneously monitored and measured as per these teachings. By one approach this measuring activity can occur in real time or in near real time. If desired, this measuring capability can be placed in series with the packet stream itself. By another approach, however, this measuring activity can be applied to a mirrored packet stream. The latter approach may be preferred in at least some application settings to aid in avoiding unwanted latency with respect to that packet stream.

By one approach this measuring step 101 can occur discontinuously. By another approach, however, these measurements can occur on at least a substantially continuous basis. As one illustrative example in these regards, and without intending any particular limitations in these regards, this can comprise performing these peak-throughput measurements for essentially all mobile users of the mobile network, whenever such mobile sessions occur and for as long as those mobile sessions occur. As this can be done without unduly burdening the network itself, and as such an approach will yield a rich store of useful information, this approach may be preferred by many network administrators.

On the other hand, useful results can also accrue when limitations in these regards are observed. For example, certain mobile users and/or certain mobile sessions may be intentionally ignored for any number of reasons. It would also be possible to intentionally ignore all or portions of certain mobile sessions in response to any number of criteria or even on a random or pseudorandom basis if desired.

In any event, at step 102 this process filters the aforementioned peak-throughput values to remove peak-throughput values that correspond to mobile data sessions that fail to at least meet a relevant standard. Such a step 102 will yield a corresponding output of filtered peak-throughput values.

The aforementioned standard can of course vary with the needs and/or opportunities that tend to characterize a particular application setting. By one approach, for example, applying this standard might comprise requiring that the mobile data session be one that transports at least a minimum predetermined quantity of data. This can be helpful because mobile data sessions serving to transport only a relatively small amount of data (such as, for example, files having less than fifty-thousand bytes of data) might never actually reach an available peak-throughput rate. (It will be understood that what constitutes a “relatively small amount of data” can vary with a variety of factors including the underlying implementing technology. A medium-speed network, for example, could have a lower threshold as the cut-off point in these regards while a higher-speed network could utilize a higher threshold. Generally speaking, this “relatively” will pertain, for the most part in many application settings to the capacity being provided to the user.) In such a case, the relatively low peak-throughput rate experienced by such a mobile data session may not offer a useful or fair representation of the network's capabilities in these regards.

These teachings will accommodate other filtering criteria as well as desired. As one optional and illustrative example in these regards, and again without intending to suggest any limitations in these regards, this process 100 will readily accommodate an optional step 103 to filter the aforementioned peak-throughput values to remove peak-throughput values that correspond to portions of mobile data sessions where data-throughput speeds are intentionally low for reasons other than throughput-limiting conditions. For example, the well-known Transmission Control Protocol (TCP) can provide for relatively low initial data-transmission rates at the beginning of a session. As receipt acknowledgments are received the transmitting entity incrementally ratchets the transmission rate upwardly to eventually utilize a reliable, fastest, presently-available transmission rate. In such a case, this optional step 103 will permit peak-throughput measurements that reflect such a window of activity to be removed from further consideration. Such an approach can be helpful to avoid negatively and inappropriately skewing a view of the network's capabilities due to low peak-throughput values that do not, in fact, reflect the current capabilities of the network.

These teachings will readily accommodate other filter criteria of interest as desired, in lieu of the foregoing or in combination therewith. For example, it may be useful in some cases to filter out or adjust user experience threshold values of data sessions that use certain device types and/or certain service groups that can inappropriately skew the desired view of network capabilities.

In any event, the peak-throughput values collected via this process 100 can be leveraged in any of a variety of ways. As one illustrative, non-limiting example in these regards, this process 100 can further accommodate the optional step 104 of using the filtered peak-throughput values to aggregate statistics regarding peak-throughput performance for the mobile network.

For example, this information can be aggregated to provide statistics on an individual mobile network service-delivery component basis. These statistics can be actual measurement values, if desired, or can be represented as user-experience indices to represent results above and/or below one or more user experience thresholds. This can comprise providing such statistics for essentially any service-delivery component (or group of components) of interest. Examples include, but are certainly not limited to, individual cells/cell sites, network switches, packet-processing units, links and groups of links, servers, and any other network element of choice. So configured, a network administrator can utilize actual and/or relational information regarding the peak-throughput statistics for individual network components to inform their decisions regarding maintenance, reconfigurations, replacements, and/or supplementation.

As another example, these statistics can be aggregated on a user-by-user basis. Again, such statistics can comprise actual measurement values or can comprise, for example, user experience indices (based, if desired, on eliminating and/or adjusting user experience thresholds to accommodate external factors that might inappropriately skew the results such as device type or service group). Using this approach, for example, a service provider can gain a clear understanding and appreciation of any given end-user's quality-of-service experience. This information can be used internally for any of a variety of useful purposes and/or can even be made available to the end users if desired.

As yet another example in these regards, these statistics can be aggregated based on service class. Using this approach these peak-throughput statistics can be leveraged to better understand, for example how different service classes (such as Web browsing, Web-based video streaming, Web-based audio streaming, email, P2P, file transfers, and so forth) fare with respect to peak-throughput experiences.

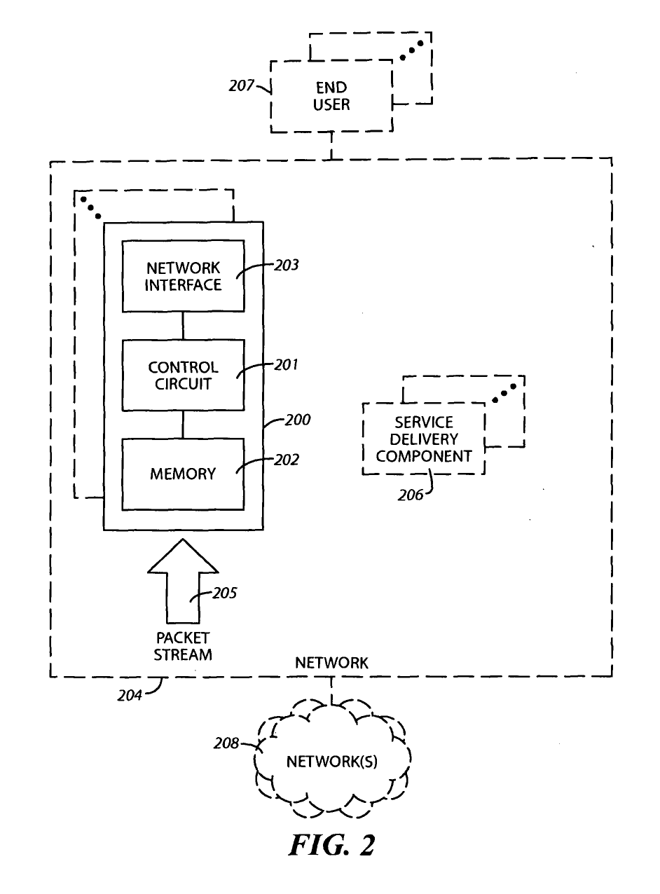

The above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example the implementing network monitoring device 200 comprises a control circuit 201 that operably couples to a memory 202 and a network interface. Such a control circuit 201 can comprise a fixed-purpose hard-wired platform or can comprise a partially or wholly programmable platform. All of these architectural options are well known and understood in the art and require no further description here.

The memory 202 can store whatever information and/or programming may be useful. For example, this memory 202 can store the aforementioned peak-throughput measurements and values, the filtering criteria, and so forth. When the control circuit 201 comprises a partially or wholly-programmable platform, this memory 202 can also serve to store the programming instructions that, when executed by the control circuit 201, cause the control circuit 201 to carry out one or more of the steps, actions, and/or functions described herein as desired.

The network interface 203, in turn, is configured to permit the control circuit 201 to interact with other components of the relevant network 204 (which may comprise, for example, a mobile network) or to, at the least, permit the network monitoring device 200 to receive the aforementioned packet stream 205 (or streams as the case may be). So configured, the network monitoring device 200 is appropriately placed and configured to monitor the data sessions for one, some, or all of the network's end users 207. This can include both data sessions that are internal to the network 204 (for example, when one end user conducts a data session with another end user of the network 204) as well as data sessions that couple end users 207 via the network 204 to one or more other networks 208 (such as, but not limited to, the Internet).

Various service-delivery components 206 as comprise a part of the network 204 will typically comprise a part of any given data session. As noted above, these teachings can serve, if desired, to provide aggregated statistics regarding peak-throughput values for individual ones of these service-delivery components 206 to assess their relative efficacy with respect to the end user's quality of service.

Those skilled in the art will recognize and appreciate that these teachings are highly flexible in practice and can be configured to leverage any of a variety of existing platforms and are also readily scaled to accommodate a variety of differently-sized and/or configured networks and operating environments. It will therefore be understood that the following examples are offered for the purpose of illustration and without any intent to suggest limitations by way of specificity.

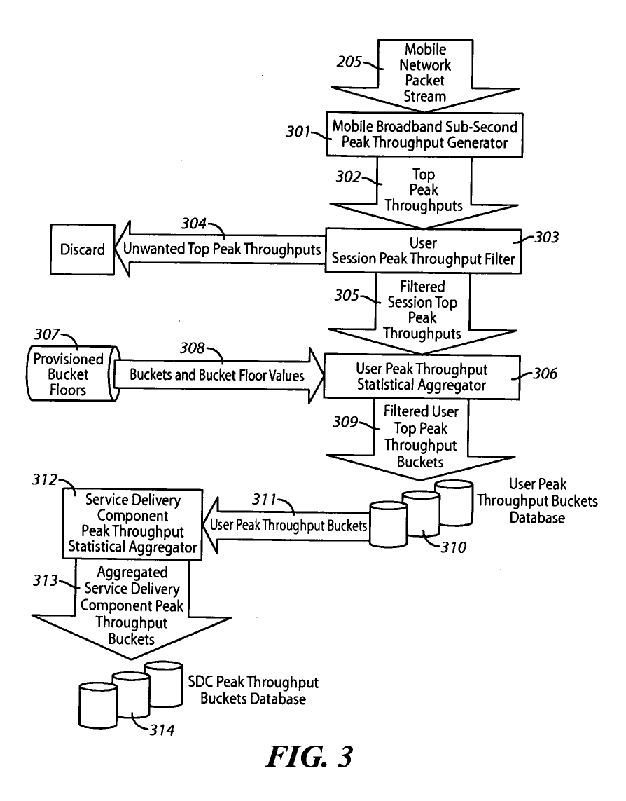

With the foregoing in mind, FIG. 3 depicts providing a mobile network packet stream 205 to a mobile broadband sub-second peak throughput generator 301. In this example this generator 301 makes sub-second peak-throughput measurements of each mobile data session and generates corresponding peak-throughput values on a per-mobile-data-session basis for every reporting interval of choice.

These results, referred to here as top peak throughputs 302, are then provided to a user session peak throughput filter 303. This filter 303 processes the top peak throughputs 302 and filters out unwanted top peak throughputs 304 which are then, in this example, discarded. This filtering is based on specific predetermined criteria regarding user session traffic characteristics (in this example, data volumes for a reporting interval).

The resultant filtered session top peak throughputs 305 are then provided to a user peak throughput statistical aggregator 306. This aggregator 306 takes this input from multiple user sessions and aggregates that input into filtered user top peak throughput buckets 309. In this example the aggregator 306 uses a corresponding bucketing algorithm that employs specific buckets and corresponding bucket floor values 308 as acquired from a store of previously-provisioned bucket floors 307. The resultant filtered user top peak throughput buckets 309 are then saved in a corresponding user peak throughput buckets database 310 to facilitate their use for statistical reporting of end user quality of experience on peak throughputs.

For example, here, a service delivery component peak throughput statistical aggregator 312 receives information corresponding to user peak throughput buckets 311 and aggregates that information into service delivery component peak throughput buckets 313 that are then saved in a service delivery component peak throughput buckets database 314. These buckets can then be used for statistical reporting of end-to-end peak throughput quality of experience for each of the monitored network's service delivery components.

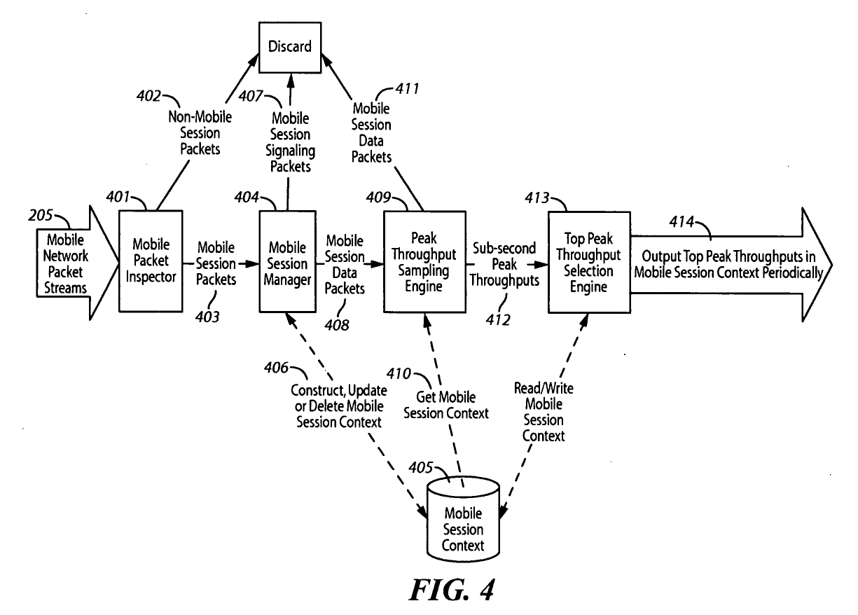

Referring now to FIG. 4, additional details regarding the aforementioned mobile broadband sub-second peak throughput generator 301 will be provided. In this example a mobile packet inspector 401 receives the incoming mobile network packet stream 205 and discards non-mobile session packets 402. Mobile session packets 403 then pass to a mobile session manager 404. The mobile session manager constructs, updates, or deletes mobile session contexts 406 in a mobile session context database 405. Each mobile session context includes the mobile session context states (such as context creation and deletion), events (such as context update), and the context traffic characteristics (such as data volumes, context duration, context air time, and so forth). This mobile session manager 404 then forwards only the mobile session data packets 408 to the next processing entity and discards the mobile session signaling packets 407.

A peak throughput sampling engine 409 receives this input and obtains the mobile session context 410 for each session data packet and performs sub-second sampling of the volume to calculate the peak throughputs for a given reporting interval. This engine 409 then discards the mobile session data packets 411 while outputting the sub-second peak throughputs 412 for each session for a corresponding reporting interval.

A top peak throughput selection engine 413 then takes these sub-second peak throughputs 412 of each user session for a reporting interval and, in this example, selects only the highest peak throughputs of each session for a given reporting interval to provide as the output 414. In many application settings most of the peak throughput measurements in a given reporting interval for a given session are from a low-volume period; accordingly, selecting only a few top peak throughputs for a reporting interval can permit skipping most or all of the lowest peak throughputs that necessarily result when only low data volumes are being transported.

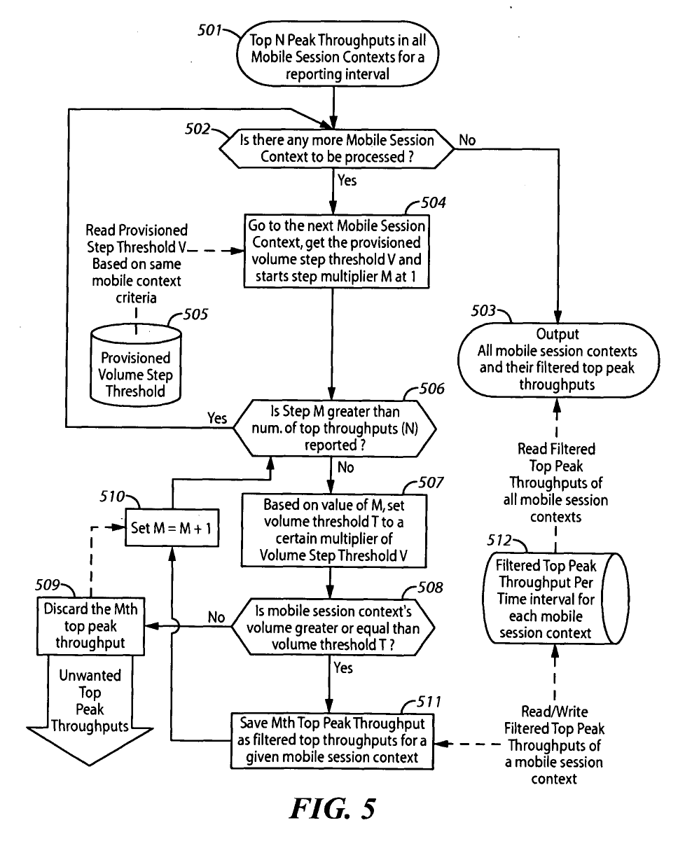

Referring now to FIG. 5, a further instantiation of the aforementioned user session peak throughput filter 303 will be described.

This filter process begins by receiving the top N peak throughputs 501 for all mobile session contexts for a given reporting interval. The filter then decides 502 if there are any more mobile session contexts to be processed. If not, the filter outputs 503 all mobile session contexts and their filtered top peak throughputs.

Otherwise, the filter processes 504 each mobile session context one at a time from the mobile contexts received from the aforementioned mobile data sub-second peak throughput generator 301. The filter uses that mobile context information and looks up a provisioned volume step threshold 505. The filter also starts a step multiplier M beginning with 1. (This “step multiplier” controls the proportional inclusion of more or fewer top peak throughputs as qualified top peak throughputs.)

The filter then determines 506 if Step M is greater than the reported number of top throughputs (N). When still true, the foregoing steps are repeated. Otherwise, using the current value of M, the filter sets 507 a volume threshold T to a certain multiplier of the volume step threshold V. For example, T=M*V. This parameter “V” can be selected based on the underlying characteristic of the utilized TCP methodology and the network. For instance, TCP protocol usually needs at least 100 KB to 150 KB volume to get past an initial slow-start period in order to fully utilize the available network bandwidth in the download direction for a typical high-speed network. In such a case a value of V=150 KB can serve as a useful default number for the download direction. For the upload direction, since the mobile upload network bandwidth is usually smaller or slower, this V may be smaller (such as 50 KB).

Other ways that could produce different sets of distribution (which may be better or worse depending upon the application setting) is to make it non-linear proportional. For instance, the aforementioned formula can be changed to T=M*(N*V). Assuming for the sake of illustration that N=4 top peaks and V=100 KB, then the original formula T=M*V would produce 100 KB, 200 KB, 300 KB and 400 KB; i.e. four step volume filter thresholds linearly proportional to N. Using T=M*(N*V), however, then the same parameter assumptions will yield these four volume filter thresholds—100 KB, 400 KB, 900 KB, and 1600 KB. This new formula is, of course, exponentially proportional to N².

The filter then compares 508 the mobile session context's volume against the volume threshold T. When the context's volume is less than this volume threshold T, the filter discards 509 the Mth top peak throughput, increments M by 1 (at step 510), and returns to step 506 to again determine if step M is greater than the reported number of top throughputs N. (The Mth top peak throughput is filtered out because the end user is operating with an inefficient volume of data to send/receive.)

When the context's volume is equal to or greater than this volume threshold T, however, the filter saves 511 the Mth top peak throughput as one of the filter top peak throughputs for that time interval for that end user in the filtered top peak throughput per time interval for each mobile session context data base 512. This stored filtered top peak throughputs information for all mobile session contexts can then be read to facilitate the aforementioned output 503.

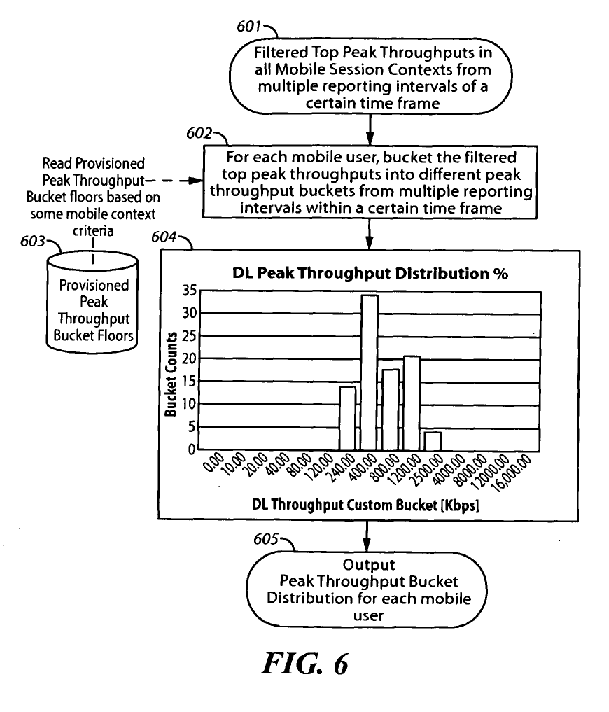

Referring now to FIG. 6, a first illustrative example as regards statistics aggregation will be described. This process can be carried out, for example, by the aforementioned user peak throughput statistical aggregator 306.

In this example the aggregator collects 601 the filtered top peak throughputs in all mobile session contexts from multiple reporting intervals within a certain time frame (such as, for example, a week, or a month, though shorter or longer durations are certainly possible). At step 602, and for each mobile user, the aggregator buckets that user's filtered top peak throughputs from multiple reporting intervals within the specified certain time frame. The number of buckets and the peak throughput floor value of each bucket are obtained from a memory store 603 and are provisioned by the system operator to fit their peak throughput range.

The bucketed filtered top peak throughputs for a particular individual end user over a specified time frame (such as one week, one month, one year, or some other duration of interest) is then plotted at step 604 to extract and depict the end-user's peak throughput statistical distribution over time to gauge this particular end user's peak throughput Quality of Experience (QoE). This information can then be output 605 as desired.

There are at least several possible ways of utilizing these statistics for Quality of Experience management. One way is to see what percentage of end user-experienced peak throughputs in fact exceed guaranteed peak throughput performance.

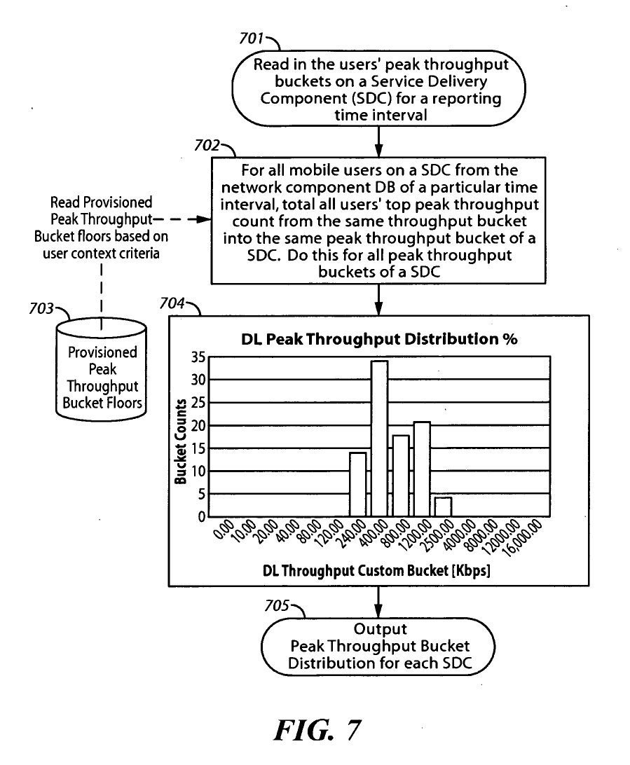

Referring now to FIG. 7, a second illustrative example as regards statistics aggregation will be described. This process can be carried out, for example, by the aforementioned service delivery component peak throughput statistical aggregator 312.

This process begins with the collection 701 of the user peak throughput buckets of all mobile session contexts on a particular service delivery component within a reporting time interval. At step 702 the aggregator then reads in the provisioned peak throughput bucket floors from a corresponding data store 703 that is based on selected user context criteria. Then, for all end users on the service delivery component within a particular reporting time interval, the aggregator totals all end users' top peak throughput counts from the same throughput bucket into the same peak throughput bucket for that service delivery component.

This can be done for all peak throughput buckets of a given service delivery component over a given time frame as before and can again be plotted 704 to reveal the user's peak throughput statistical distribution over time to gauge peak throughput Quality of Experience for the network's end-to-end service delivery components. This resultant information can then be output 705 to serve any number of purposes and to inform any number of decisions and judgments regarding, for example, network capacity planning, network optimization, device management, and so forth,

So configured, these teachings are readily leveraged to provide any number of useful views of a given network. The concept of filtering to eliminate one or more external factors (such as inherently-slow devices or services that do not utilize high throughput speeds) greatly facilitates, for example, benchmarking the various service delivery components of a given mobile network. The peak throughput values determined pursuant to these teachings, freed partially or wholly from such external factors provide better network intelligence and/or a better understanding of when and whether the user is receiving a good user experience

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network monitoring device:
performing peak-throughput measurements for each of a plurality of mobile data sessions in a mobile network to provide corresponding peak-throughput values;
filtering the peak-throughput values to remove peak-throughput values that correspond to mobile data sessions that fail to at least meet a relevant standard to provide filtered peak-throughput values.

2. The method of claim 1 wherein performing peak-throughput measurements for each of a plurality of mobile data sessions comprises performing peak-throughput measurements based upon at least one packet stream in a mobile data network.

3. The method of claim 1 wherein the relevant standard comprises, at least in part, a mobile data session transporting at least a minimum predetermined quantity of data.

4. The method of claim 1 further comprising:
filtering the peak-throughput values to remove peak-throughput values that correspond to portions of mobile data sessions where data-throughput speeds are intentionally low for reasons other than throughput-limiting conditions.

5. The method of claim 1 wherein performing peak-throughput measurements comprises performing a plurality of sub-second peak-throughput measurements.

6. The method of claim 1 wherein performing peak-throughput measurements for each of a plurality of mobile data sessions to provide corresponding peak-throughput values comprises, at least in part, substantially continuously performing the peak-throughput measurements to thereby provide the corresponding peak-throughput values for multiple mobile data sessions for at least one mobile users of the mobile network

7. The method of claim 1 further comprising:
using the filtered peak-throughput values to aggregate statistics regarding peak-throughput performance for the mobile network.

8. The method of claim 7 wherein aggregating statistics regarding peak-throughput performance for the mobile network comprises aggregating the statistics on an individual mobile network service delivery component basis.

9. The method of claim 7 wherein aggregating statistics regarding peak-throughput performance for the mobile network comprises aggregating the statistics on a user-by-user basis.

10. An apparatus comprising:
a network interface;
memory;
a control circuit operably coupled to the network interface and the memory and configured to:
perform peak-throughput measurements for each of a plurality of mobile data sessions in a mobile network to provide corresponding peak-throughput values;
filter the peak-throughput values to remove peak-throughput values that correspond to mobile data sessions that fail to at least meet a relevant standard to provide filtered peak-throughput values.

11. The apparatus of claim 10 wherein the control circuit is configured to perform peak-throughput measurements for each of a plurality of mobile data sessions by performing peak-throughput measurements based upon at least one packet stream in a mobile data network.

12. The apparatus of claim 10 wherein the relevant standard comprises, at least in part, a mobile data session transporting at least a minimum predetermined quantity of data.

13. The apparatus of claim 10 wherein the control circuit is further configured to:
filter the peak-throughput values to remove peak-throughput values that correspond to portions of mobile data sessions where data-throughput speeds are intentionally low for reasons other than throughput-limiting conditions.

14. The apparatus of claim 10 wherein the control circuit is configured to perform peak-throughput measurements by performing a plurality of sub-second peak-throughput measurements.

15. The apparatus of claim 10 wherein the control circuit is configured to perform peak-throughput measurements for each of a plurality of mobile data sessions to provide corresponding peak-throughput values by, at least in part, substantially continuously performing the peak-throughput measurements to thereby provide the corresponding peak-throughput values for multiple mobile data sessions for at least one mobile users of the mobile network

16. The apparatus of claim 10 wherein the control circuit is configured to:
use the filtered peak-throughput values to aggregate statistics regarding peak-throughput performance for the mobile network.

17. The apparatus of claim 16 wherein the control circuit is configured to aggregate statistics regarding peak-throughput performance for the mobile network by aggregating the statistics on an individual mobile network service delivery component basis.

18. The apparatus of claim 16 wherein the control circuit is configured to aggregate statistics regarding peak-throughput performance for the mobile network by aggregating the statistics on a user-by-user basis.
